(19) United States
(12) Patent Application Publication
(10) Pub. No.: US 2005/0273250 A1
(43) Pub. Date: Dec. 8, 2005

(54) System and method for dynamic navigational route selection

(76) Inventors: Bruce Hamilton, Menlo Park, CA (US); Jerry Liu, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/847,817

(22) Filed: May 18, 2004

(51) Int. Cl. G01C 21/26

(52) U.S. Cl. 701/200; 701/201

(57) ABSTRACT

A navigation system and method factors into its routing decisions information pertaining to transient delays encountered from time to time, one example of such a transient delay is accident information obtained from currently available broadcast traffic flow sources. The system can also factor in historically available traffic delay data based on time of day or other parameters. The navigation system keeps track of the routes traveled by the vehicle (or user) and the times of transit of such routes. When a user requests a route based upon given end-points, the navigation system can use its own stored historical data, as well as currently available traffic delay data, to calculate and announce a given route.

### TECHNICAL FIELD

This invention relates to navigation systems and more particularly to systems and methods for dynamic route selection in a navigation system based upon historically available traffic delay data as well as transient traffic delay data.

### BACKGROUND OF THE INVENTION

It has become common practice to use car navigational systems (some of which obtain their positional data from Global Positioning Systems (GPS)) to allow drivers to set desired end-points of a trip. The user's navigation system then selects a route based upon the determined position of the user. This route is usually a combination of surface streets, highways and limited access highways. The user could ask the system to avoid certain types of roads, such as limited access highways, if desired. However, every command given to such a system is distracting from other tasks, such as driving, and takes time as well as presupposing a knowledge of the available routes.

The navigation system then, based upon the given end-points, and any other selected criteria, determines the best route. Typically, drivers desire a route having the fastest transit time between the given end-points. This fastest transit time can be calculated by the system assigning a speed for each segment (usually based on street type) of the route and then adding together the various calculated individual transit times to select the combination of streets or routes yielding the fastest anticipated transit time between the given end-points. Such systems do not take into consideration known traffic delays on given routes, such as rush-hour bridge congestion, and also do not take into account transient delays, such as accidents, highway repair, and other delays on certain routes.

While such delay information is often available, for example, from the radio, this information then would require the navigation device user (who is often the driver) to enter information into the navigation system in order to obtain alternate routings. This presupposes that the user knows the area in which the user is navigating. Such a presupposition is usually contrary to the reason why the navigation device is being used to begin with. However, even if the user had information about a traffic delay, or about a traditionally slow route at a given time, just inputting such information into the navigation device is often physically difficult, particularly when transient delay information arrives after the trip has started. When the user is new to an area, for example, when using a rental car in an unfamiliar city, any such manually provided alternate information is not a viable option. In addition, for safety reasons, navigational systems often will not accept user input while the vehicle is operational.

### BRIEF SUMMARY OF THE INVENTION

In one embodiment, a navigation system and method factors into its routing decisions information pertaining to transient delays encountered from time to time. One example of a transient delay is accident information obtained from currently available broadcast traffic flow sources. The system can also factor in historically available traffic delay data based on time of day or other parameters, as well as data available from other vehicles traveling the same roadway. These “other” vehicles could be going in the same direction as the user (but ahead of the user), or the “other” vehicles could be going in the opposite direction and giving information on past travel conditions. Typically, this information would be in terms of speeds on certain roadway segments.

In another embodiment, the navigation system keeps track of the routes traveled by the vehicle (or user) and the times of transit of such routes. Thus, when a user requests a route based upon given end-points, the navigation system can use its own stored historical data, as well as currently available traffic delay data, to calculate and announce a given route. This is accomplished without requiring the user to enter any alternate data other than the given end-points and other normal parameters. In some embodiments, the user may answer questions presented by the navigation system, all of which can be accomplished verbally, if desired.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 shows one embodiment of a sample screen of a navigation system display;

FIG. 2 is a listing of transit times for certain routes;

FIG. 3A is an illustration of a calculation of a non-rush hour times for various routes of the display of FIG. 1;

FIG. 3B is the determined route based upon the calculation of FIG. 3A;

FIG. 4A are the calculations for certain routes for the morning rush hour;

FIG. 4B is the determined route based upon the calculations of FIG. 4A;

FIG. 5A is the calculations for the morning rush hour with an accident on one of the routes;

FIG. 5B is the determined route based upon the calculations of FIG. 5A;

FIGS. 5C and 5D show determined routes made certain times after FIG. 5B showing changes in the routing;

FIG. 6 shows a block diagram of one embodiment of the system for controlling routing; and

FIG. 7 shows a flow chart of one embodiment of a portion of a navigational system.

### DETAILED DESCRIPTION OF THE INVENTION

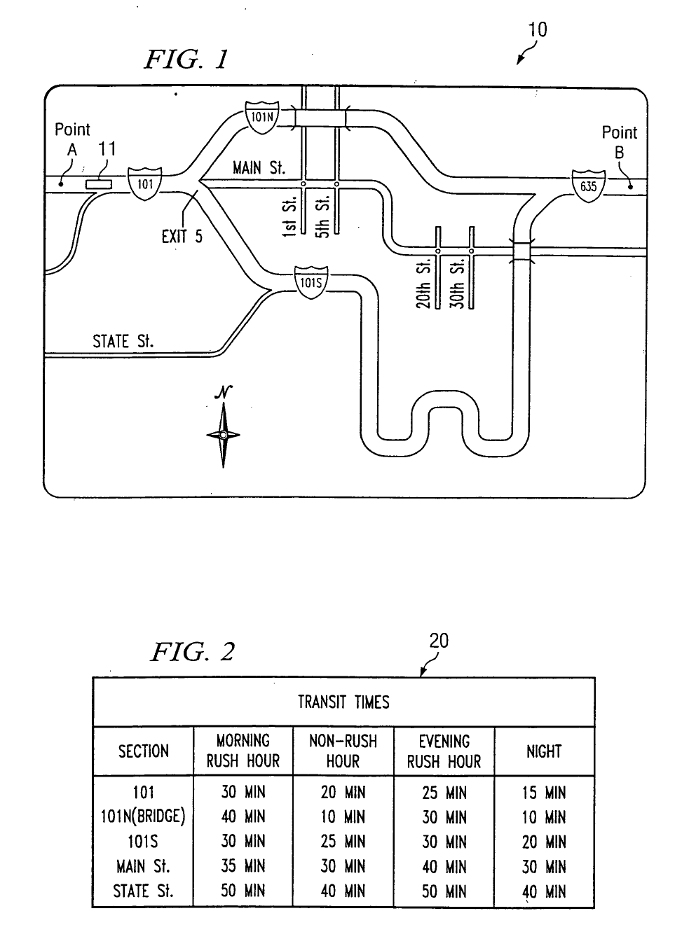

Turning now to FIG. 1, there is shown one embodiment of a navigation display screen 10 which is part of navigation system 60 (FIG. 6). Display screen 10, can if desired, include touch sensitive areas, and can include audio communication and text messages. Based upon the position of a given party, for example user 11, and instructions input into that party's navigation system, a map is generated showing the routes between a set of points A and B. Points A and B can be keypunched into system 60, or could be verbally stated. Point A and point B may be a trip that user 11 makes every day, for example from home to work, on the other hand, the trip between points A and B could be new for this user. The user would verbally or otherwise enter into system 60 preferences, such as use limited access highways when possible, or in some cases use city streets when possible. Most often, the user would have a preference to move between point A and point B in the quickest possible time. As user 11 moves between points A and B, display 10 changes to show the user's progress by for example, moving the car icon along the user's path. This positional movement is controlled based on GPS data arriving at the user's vehicle.

Systems for providing maps on displays, such as on display 10 upon different parameters input by the user are well known for navigation systems. In a typical situation, the system breaks each trip into sub-routes and uses the assigned speed for that sub-route to calculate an anticipated transit time for the trip. For example, if a particular sub-route is a limited access highway, an assigned speed might be 50 mph. If the sub-route is a surface street, the assigned speed might be 25 mph. Thus, the system, knowing whether a road is a limited access road or a surface street, will assign travel times based upon the assigned speed and distance of each segment. Thus, the system derives an overall route having the shortest transit time, assuming a short transit time is the desired metric.

FIG. 2 shows chart 20 having an example of transit times for the map on display 10 of FIG. 1. Route 101 shows a morning rush hour transit time of 30 minutes and a non-rush hour transit time of 20 minutes. While route 101N (which contains a major bridge) shows a morning rush hour time of 40 minutes and a non-morning rush hour time of 10 minutes. Times are shown for roads 101, 101N, 101S, Main St. and State St. These times are shown for morning rush hour, non-rush hour, evening rush hour, and night. Of course, this is a illustration only and many other times and sub-routes will be stored. The transit times for these sub-routes are derived from known transit speeds (multiplied by the distance of the sub-route). While transit times are shown herein for illustration purposes, the system, in all likelihood, would store the speed information for various times of day as obtained from any number of sources. The time of day criteria could be time of day, day of week, week of the year, etc., specific so as to adjust for winter, summer, weekends, holidays, vacations, etc.

The times could be straight-forward calculations, as discussed above. But, more accurate times can be achieved if the stored speeds (or times) were to be determined by prior actual driving speeds (or times) of this user. Alternately, the system could track a number of users and obtain a statistical average, which could change periodically. As discussed above, the system could also obtain very current information from users currently traveling (or just recently traveling) over the various sub-routes of the desired route. This current information could be delivered to the vehicle via any wireless media which could include bluetooth, wifi, or any type of broadcast signals. Also, the information could be delivered as an email message, perhaps delivered to a cell phone (or computer) associated with the vehicle, or with the user. Some of this information could be, for example, stored in data storage along the roadway and transmitted to vehicles (or requested by vehicles) as they pass in proximity to a data storage location. This information can be, for example, shared by data transfer from other passing vehicles or relayed from other storage media in other locations.

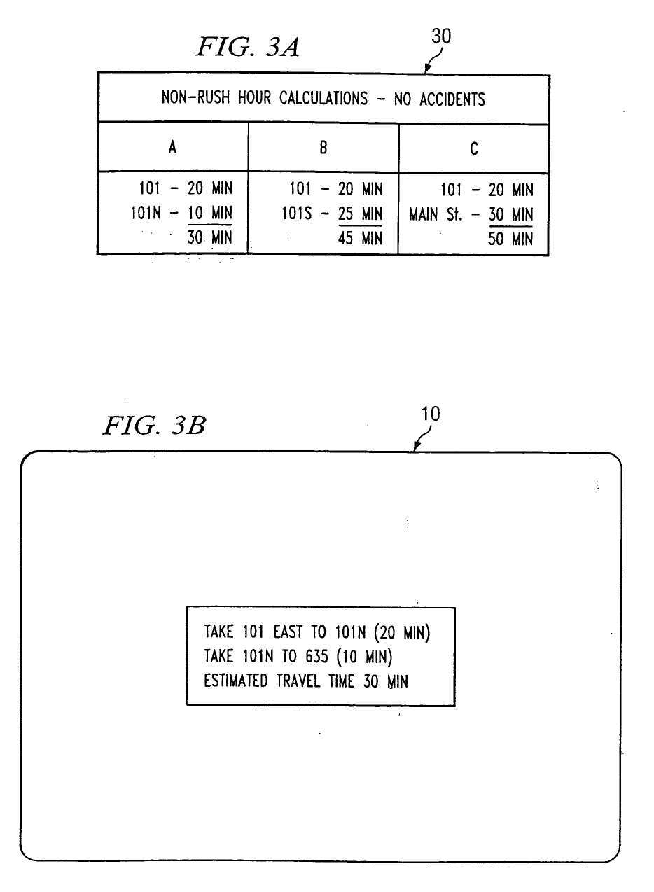

Turning now to FIG. 3A, assume a non-rush hour calculation with no accidents. In column A of chart 30 the time using routes 101 and 101N is 30 minutes. Whereas, under column B the time using route 101 and 101S is 45 minutes. Under chart C, the time using route 101N and surface Main St. is 50 minutes. Thus, the calculation would show that a user starting at point A and desiring to go to point B in the quickest possible time should follow the routes in column A.

FIG. 3B shows screen 10 displaying the route to the user. By using 101 east to route 101N and taking 101N to 635, the driving time is estimated at 30 minutes. This driving time, as discussed, is based upon the times shown in FIG. 2, which, in turn, are based upon the times statistically determined by drivers driving over these routes at various times.

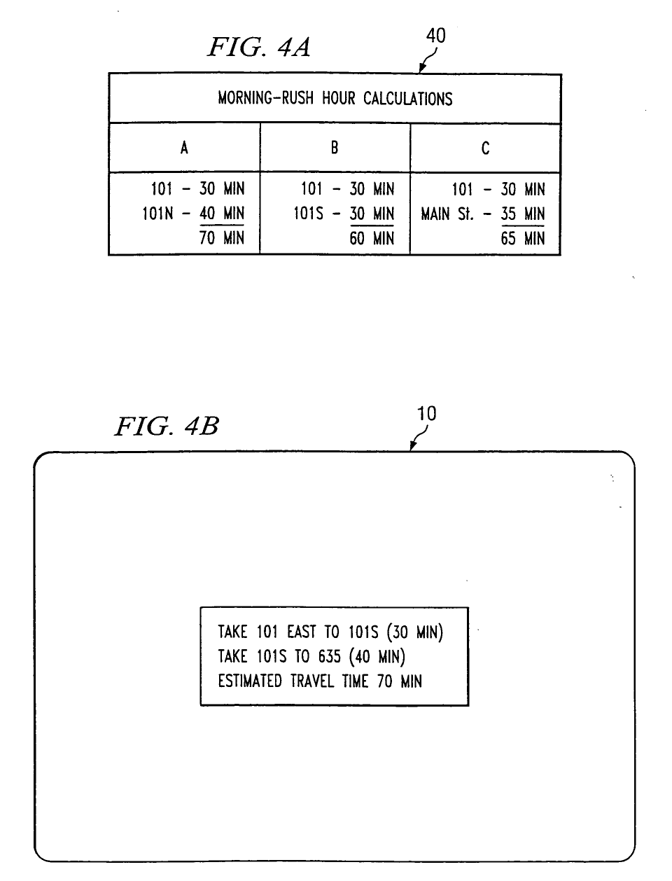

Turning now to FIG. 4A, chart 40 shows sample morning rush hour calculations. It is clear that the routes shown in column B during morning rush hour are better, even though the distance using route 101S is much longer. This is due to delays on the bridge section of 101N. Thus, as shown in FIG. 4B, the route would be to take 101E to 101S and then take route 101S to route 635 for a total estimated driving time of 70 minutes. The user would not have to make any changes or add any other keypunches or other information other than to just say (by whatever means), “Take me to point B in the quickest possible time”. Since the system has the present location of the user, the end-points of the trip are thus defined.

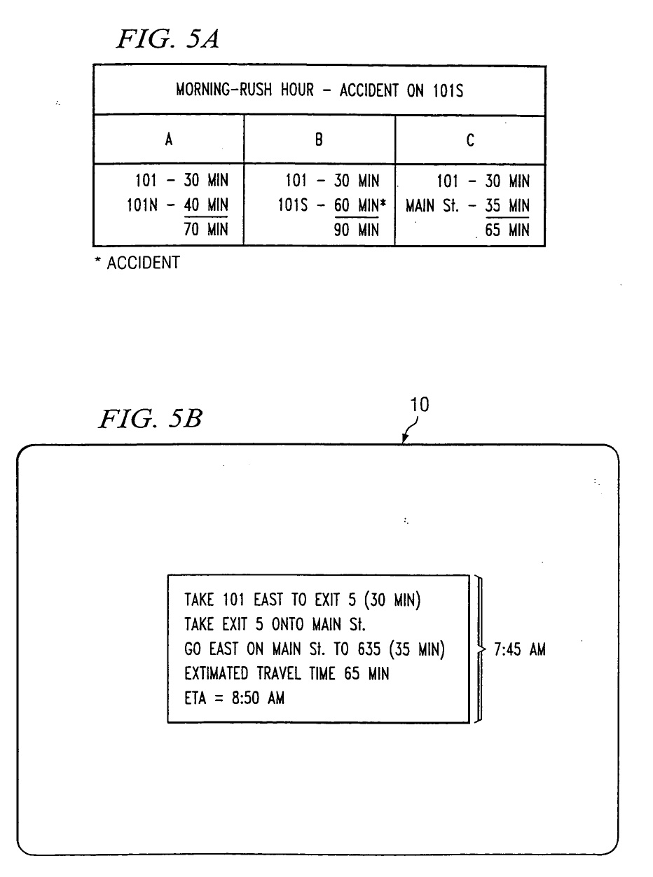

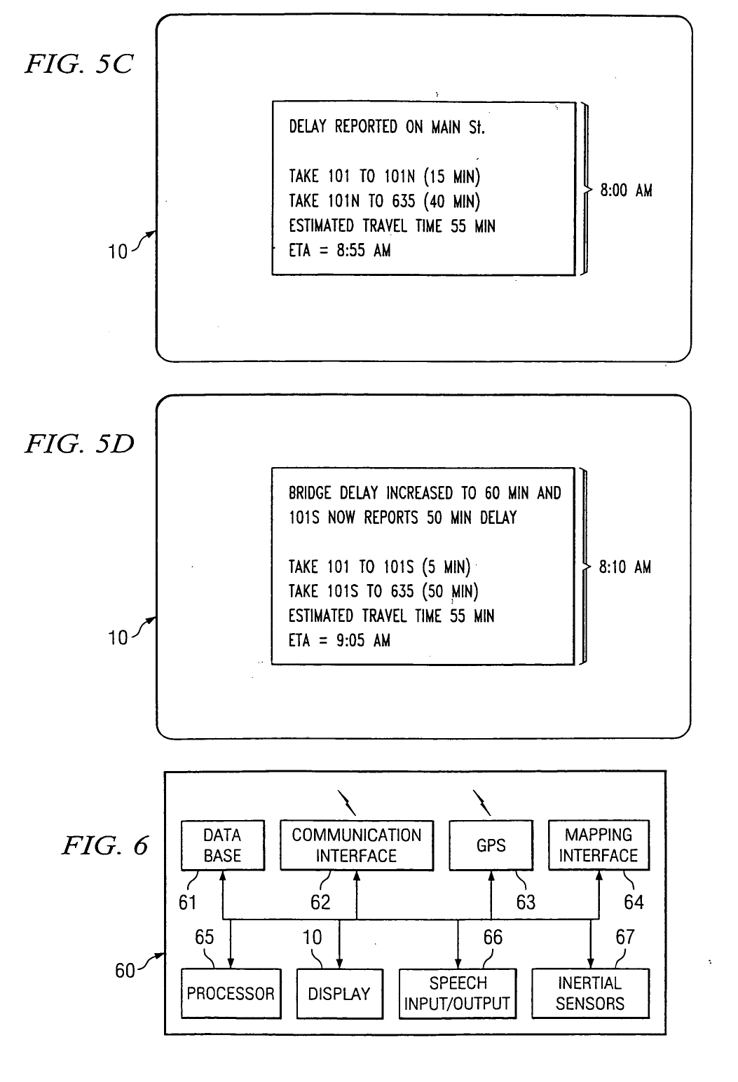

FIG. 5A shows sample calculations during the morning rush hour when there's an accident on 101S. The accident is shown in column B where 101S is shown as 60 minutes as opposed to the 30 minutes shown in FIG. 4A. This calculation then results in a surface road (main street) having the fastest travel time, as shown in FIG. 5B, display 10 (which can be audio, or a combination of audio and graphics) suggest taking 101 East to exit 5 and then taking Main street east to route 635. Estimated travel time is 65 minutes with an estimated arrival time (ETA) of 8:50 am. As noted in FIG. 5B, this calculation was made at 7:45 am when the user began the journey from point A.

The system can be programmed to repeat the travel time calculation at periodic times. These periodic times could be every minute, every 5 minutes, every 15 minutes, or perhaps only when new data becomes available. In the embodiment shown, a recalculation is made at 8:00 am, as shown in FIG. 5C when a delay (or reduced average speed) is reported on Main Street. The navigation system “knows” where the user is at 8:00 am. In this situation, the user is still on route 101. Alternatively, a calculation can be made as to where the user is at anytime, for example, since this time is only 15 minutes after the 7:45 am start time, the calculations show that the user would only be 15 minutes into his or her drive at that point and thus still on route 101. Based on this new information (the delay on Main Street), a reported change would take place such that the user would be told to take 101 to 101N which is now 15 minutes away. The user would be instructed to take 101N (instead of Main Street) to route 635. This changed routing would take 55 minutes, yielding an estimated arrival time of 8:55 am.

FIG. 5B shows that at 8:10 am the bridge delay on route 101N has increased to 60 minutes and that route 101S is now reporting only a 50 minute delay. Since the user is still 5 minutes away from the cutoff to 101N the system instructs the user to take 101 to 101S and to take 101S to route 635. This yields an estimated travel time of 55 minutes from this point and an estimated arrival time of 9:05 am.

As discussed above, the route has been dynamically changed twice during the trip, all based on newly arriving information and without intervention by the user. This information can be, for example, obtained from travel reports or other traffic or weather conditions. The traffic conditions can be actual observations of delays or could result from data obtained directly from other vehicles traveling the same roads a discussed above. In such a situation, statistical data from actual travel times can be used dynamically to help in establishing a route for any given user.

FIG. 6 shows one embodiment of a schematic of system 60 used to control the operations just discussed. Database 61 contains at least some of the information pertaining to route times and prior travel times as discussed above. Communication interface 62 receives and transmits information pertaining to delays and other information pertaining to routes. Communication interface 62 also communicates with the user to inform the user as to which routes to take. This communication can be on a screen (such as screen 10 as shown above) or verbally (such as speech output/output 66) or graphically (such as mapping interface 64). This communication can be controlled, if desired, by speech input/output control 66. GPS system 63 receives signals from satellites and other towers and uses those signals to calculate position and time between positions so as to give a precise location for the user. System can accept other input via inertial sensors 67. These inertial sensors would pick up tire rotation, change in direction, etc. to help identify the location and speed of the user. Information from GPS 63 is used both locally, and if desired, by other units (such as other vehicles) or a central system (not shown) to help plot the route to be taken. The information from GPS 63 is also used for statistical analysis to determine transit speeds between points. Mapping interface 64 operates to control the maps and to display the route information for communication to the user. The elements of system 60 operate under control of processor 65.

Note that system 60 can be arranged to keep track of actual transit speeds (or times) of various other vehicles as they move along segments of the desired route. Based on these actual speeds (or times), the system could, if desired, change the route from the original calculated route to the route showing the new fastest actual transit time. Typically, driving times (and delayed transit times) are obtained from announcers and radio broadcasts which reduced (or speeded up) speeds are obtained from other vehicles or roadway measurements.

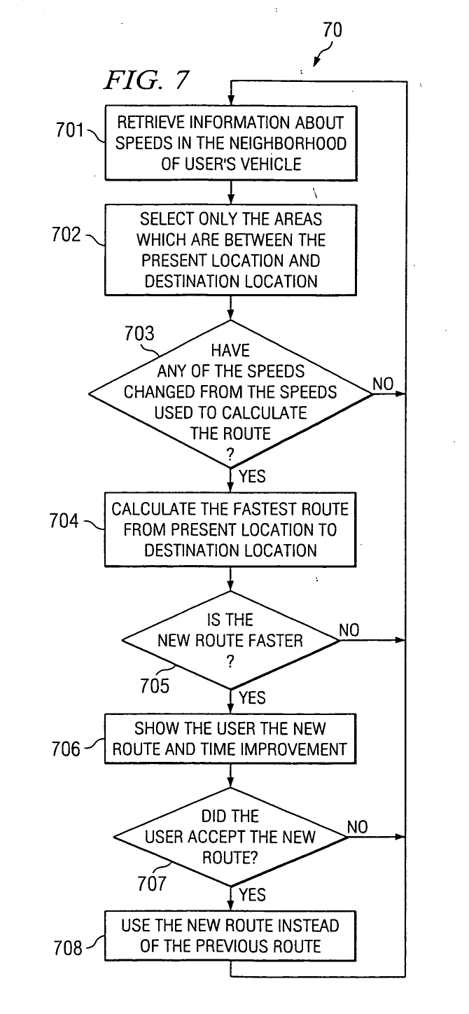

FIG. 7 shows one embodiment 70 of a flow chart which can be utilized to control the navigation system in order to provide dynamic updating of a selected route.

Process 701 retrieves information about speeds of other vehicles in the neighborhood of the user's vehicle. As discussed above, this speed information can be retrieved from memory stored along the road as obtained from other vehicles; from speed information communicated to the vehicle; from traffic broadcast data of accidents; or from any number of other sources. This communicated information can, for example, be sent to an email address associated with the vehicle or to an email address associated with the user in the vehicle. If the information is sent to the user's email address, then a communication link would be established between the memory of the user's device for receiving the information and the navigation system. Many other systems can be utilized for retrieving current speed data of vehicles traversing various sub-segments of routes.

Process 702 further refines the area for which the speed information is required. This would include the various sub-routes between the present location and a destination location of the user for this particular route.

Process 703 determines whether the speeds on the sub-routes have changed from the speeds which were used to calculate the present route information for the user.

Process 704 calculates the fastest route from the present location of the user to the destination location for this route. This fastest route would include a calculation of the speeds of the different possible sub-routes.

Process 705 determines if the newly calculated route is faster, in terms of transit time for this user than the previously calculated route.

Process 706 shows (or announces) to the user the newly calculated route and could include the time improvement gained by using this newly calculated route. This information can be provided, for example, on display 10, as discussed above, or could be orally transmitted (for example, speech input/output 66) to the user.

Process 707 determines whether the user has accepted the new route. This acceptance could be, for example, a voice command from the user, or the user could touch a screen to signify acceptance, or the user could turn at the designated next turn point of the new route and the system, upon detection of the turn, would know that the user has accepted the newly calculated route.

Process 708 displays (or announces) the new route once it is determined that the user has accepted the new route. As discussed, this display can be by text, graphics, audible, or a combination thereof.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A vehicle navigation system, said system comprising:
a navigation route indicator for presenting to a user a travel route based upon the fastest anticipated transit time between a set of points;
a receiver for accepting data pertaining to current average speeds within an area encompassed by said set of points; and
a processor for determining a particular route having the fastest anticipated transit time from among a plurality of possible routes matching said set of points, said anticipated transit time being determined, at least in part, from said accepted data.

2. The vehicle navigation system of claim 1 wherein said navigation system further comprises:
a global positioning system receiver.

3. The vehicle navigation system of claim 1 wherein said system further comprises a display for showing where said user is at various points in time.

4. The vehicle navigation system of claim 1 further comprising:
means for determining average actual speeds between often utilized end-points, said determined speeds having associated with them a time of day for which said determined speeds are valid.

5. The vehicle navigation system of claim 4 further comprising:
a memory; and wherein said current speeds are stored in said memory.

6. The vehicle navigation system of claim 5 wherein said speeds are associated with a time of day.

7. The vehicle navigation system of claim 1 wherein said current average speeds are defined in terms of traffic delays.

8. The vehicle navigation system of claim 7 wherein said data pertaining:to current average speeds is derived from at least one of the following data sources: radio broadcasts of traffic delays; e-mails directed to said navigation system; the Internet; measured average transit speed data for given route segments; cell phone, wireless broadcast from other vehicles, wireless broadcasts from data collection points.

9. The vehicle navigation system of claim 1 wherein said processor is further operable for utilizing an actual known transit time between said set of points to determine a given route if said actual known transit time is faster than said anticipated fastest transit time.

10. The vehicle navigation system of claim 1 wherein said processor is further operable for accepting updated information during the course of a transit between said given set up points and, based, at least in part, on said accepted updated information, modifying a determined route.

11. A method of determining the fastest anticipated transit time in a roadway navigation system; said method comprising:
accepting from a user at least one end-point to define a navigation route having the least transit time for said user;
factoring anticipated transit times between said end-points for each possible navigation route with historically available transit times between said end-points for each possible navigation route and with available data pertaining to currently known traffic delays between said end-points for each possible navigation route; and
based on said factoring, communicating a navigation route having the least transit time between said endpoints.

12. The method of claim 11 further comprising:
adjusting said communicated navigation route for the time of day for such transit.

13. The method of claim 11 wherein said historically available transit times between said end-points is obtained from past transits of said navigation route by said user.

14. The method of claim 11 further comprising:
modifying from time to time said communicated navigation route based upon data pertaining to currently known traffic delays between said end-points along said communicated navigation route.

15. The method of claim 13 wherein said currently known traffic delays are in terms of average speeds on route segments between said end-points.

16. The method of claim 13 wherein said currently known traffic delays are in terms of transit time between points within said end-points.

17. The method of claim 16 wherein said past transits of said navigation route are portable with respect to said user.

18. The method of claim 11 further comprising:
when said historically available transit time for the same time of day is slower than the currently known actual anticipated transit time, substituting said slower time for the currently known actual anticipated time for the historically available transit time in deriving a communicated navigation route.

19. The method of claim 11 wherein said communicating comprises:
displaying said navigation route to a user together with a graphical representation of a map showing the progress of said user along said graphically represented map.

20. The method of claim 19 wherein said progress of said user is determined by a global positioning system.

21. A vehicle navigation system operable for displaying a user's current position superimposed on a graphically represented map, said system comprising:
means for establishing routes to be traveled by said user, said routes based on a fastest transit time between various points; and
means for adjusting said routes based upon transient data received by said navigation system from time to time.

22. The vehicle navigation system of claim 21 wherein said routes are the sum of route segments and wherein said fastest time is calculated from transit times for each such route segment.

23. The vehicle navigation system of claim 22 wherein each said route segment transit time is calculated from measured actual sub-route transit times.

24. The vehicle navigation system of claim 22 wherein said transit data is generated by other vehicles traveling said route segments.
